(19) United States
(12) Patent Application Publication
(10) Pub. No.: US 2009/0232944 A1
(43) Pub. Date: Sep. 17, 2009

(54) FLEXIBLE PAD FOR PREPARING A BEVERAGE

(76) Inventors: John MacMahon, Oxon (GB); Susan Bodett, Glenview, IL (US); Mark Norton, Oxon (GB); Satwinder Panesar, Oxon (GB); Lee Rowan, Oxon (GB); Joseph Giacone, Tarrytown, NY (US); Heather Hudson, Glenview, CA (US); Anilkumar Gaonkar, Buffalo Grove, IL (US); Bary Zeller, Glenview, IL (US)

Correspondence Address: FITCH EVEN TABIN & FLANNERY, 120 SOUTH LASALLE STREET, SUITE 1600, CHICAGO, IL, 60603-3406, US

(21) Appl. No.: 11/577,169

(22) PCT Filed: Oct. 24, 2005
(86) PCT No.: PCT/GB2005/004095

§ 371 Date: Mar. 20, 2009

(30) Foreign Application Priority Data
Oct. 22, 2004 (GB) .0423553.7

(51) Int. Cl. B65B 29/02; A47J 31/00; B67D 5/00; A23L 2/52

(52) U.S. Cl. 426/78; 99/295; 222/1; 426/590

(57) ABSTRACT

The present invention provides a flexible pad (10) for preparing a beverage comprising: a flexible bag defining a storage volume (13); the storage volume containing a water-soluble composition or a combination or mixture of water-soluble compositions for forming a beverage; wherein at least a part of the flexible bag is formed from a flexible water-impermeable thin sheet material (11, 12), wherein said flexible water-impermeable thin sheet material comprises one or more apertures (40, 41) defining an inlet or an outlet of the storage volume.

The present invention relates to improvements in pads for preparing beverages which contain a water soluble substance. The water soluble substance may be a powdered ingredient for making a beverage such as coffee, tea or soup, fruit juice and desserts. The invention finds particular advantage where the water soluble substance is a milk powder, creamer powder or chocolate powder. The pads are also known as pods, cartridges, capsules, pouches and bags.

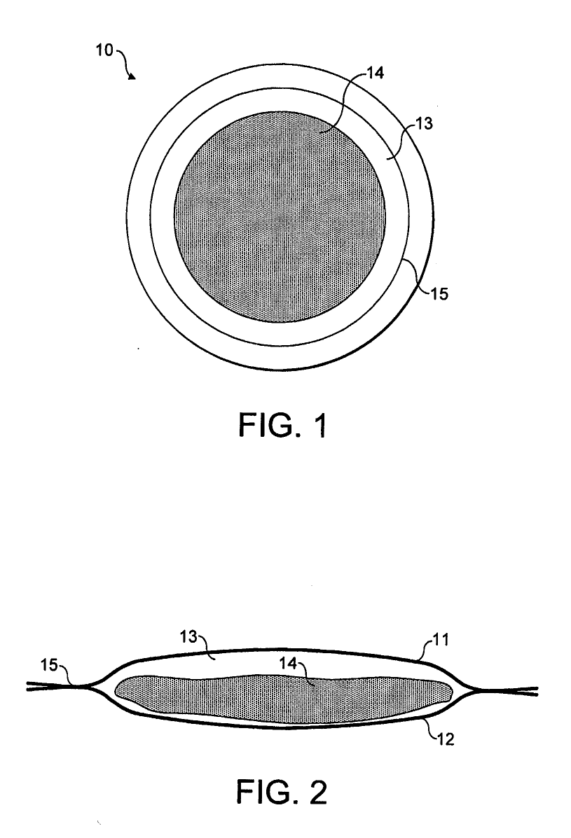

An example of a known pad is shown in FIGS. 1 and 2. The pad 10 is simple in construction and comprises a circular upper sheet 11 and a circular lower sheet 12 of filter material which are bonded together around a peripheral seam 15 to define and seal a storage volume 13 in which the water soluble substance 14 is contained. In use, the pad 10 is placed in a beverage preparation machine such as a coffee brewer and heated water is passed through the pad 10. The heated water flows through the upper sheet 11 and lower sheet 12 of filter material and in so doing contacts and dissolves the water soluble substance 14 contained in the storage volume 13 to form the beverage. The beverage then passes through the lower sheet 12 of the filter material and is dispensed into a suitable receptacle. The water soluble substance may be used to form the whole or part of a beverage. Where the water soluble substance is a milk powder or creamer powder, the pad may be used to form a milk- or creamer-based beverage or to form a milk- or creamer-based portion of an alternative beverage such as coffee.

Pads with creamer powders or milk based products may be used in dispensing cappuccino-style beverages. Such pads may be used in the beverage preparation machine on their own to dispense a milky, creamy or frothy beverage portion onto an already dispensed beverage, such as coffee. Alternatively, the pad containing the creamer powder or milk-based substance may be used in the beverage preparation machine in combination with a pad containing a substance for producing another beverage portion. For example, two pads may be used at the same time in the machine, one pad containing a creamer powder and one pad containing roast and ground coffee as taught in EP0756844. In this way, a complete beverage may be dispensed in one operation cycle of the beverage preparation machine.

The pads described above are similar to well known tea bags which are used for infusing hot water with tea leaves. However, there are a number of particular problems in using such flexible pads in beverage preparation machines where the pads contain a water soluble product such as a milk powder or creamer powder as opposed to a product which is infused in water but is not itself dissolved, such as roast and ground coffee or tea leaves. One disadvantage is that as the water soluble substance 14 is dissolved by the water passing through the pad, the pad tends to collapse in on itself bringing the upper sheet 11 and lower sheet 12 of filter material into contact with one another. In addition, because the dissolution of the water soluble substance 14 is not necessarily uniform throughout the storage volume of the pad 10 during use this can lead to portions of the filter material collapsing before the whole or a substantially part of the water soluble substance 14 has been dissolved. Where the upper sheet 11 and the lower sheet 12 of filter material contact one another, there is formed a low resistance flow path for the heated water. As a result, as soon as the pad 10 starts to collapse, the heated water has a tendency to flow through the portions of the pad 10 where the upper sheet 11 and lower sheet 12 are in contact rather than flowing more uniformly through the entire storage volume of the pad 10. This problem is exacerbated where the pad is used in a beverage preparation machine together with another pad containing another beverage portion as described above. It is preferred in such one-step dispensing of a beverage that the pad containing the infusible substance such as roast and ground coffee is placed on top of the pad containing the water soluble product so as to ensure proper extraction of the infusible substance as taught in EP0756844. However, the additional weight of the pad containing the infusible substance increases the likelihood that the pad containing the water soluble substance will collapse during the dispense cycle. For these reasons, use of pads such as those shown in FIGS. 1 and 2 can lead to substantial portions of the water soluble substance 14 being left within the pad 10 after the beverage preparation machine has completed its dispense cycle. Experiments show that for commonly used creamer powders as much as 40 to 60% of the creamer powder remains in the pad at the end of the dispense cycle. (The actual amount left depends to some extent on the dissolution properties of the creamer powder. Typically, the rate of flow of water is such that the beverage is prepared in under one minute. It is known with some compositions to include filler agents. This may result in poorer dissolution of the composition and an increased amount remaining in the pad after use. In contrast, the dissolution properties can be improved by use of agents such as surfactants. However, use of such agents has been found to result in only limited reduction in the amount of the substance left in the pad after use). This disadvantage of this simple pad arrangement is that it can lead to a beverage or beverage portion being dispensed which is weaker than intended and also leads to wastage of the water soluble substance 14. Weak beverages can also be dispended where the ingredients or part of the ingredients are by-passed by part of the water flow during dispensation.

Attempts have been made to overcome this problem by providing a form-retaining stiffening body within the interior of the storage volume 13. EP1398279 discloses use of a form-providing stiffening body comprising a grid structure that itself comprises a compartmenting wall configuration that spans between the upper and lower sheets of the flexible pad. Whilst the form-providing stiffening body prevents collapse of the pad and contact of the upper sheet and lower sheet of filter material, the structure described is complex and increases the cost and complexity of manufacture compared to the simpler pad as shown in FIGS. 1 and 2. In addition, the compartmenting wall configuration of the pad necessitates more careful filling of the storage volume with the water soluble substance to ensure consistent filling of the compartments.

Another disadvantage with the simple flexible pads of FIGS. 1 and 2 and the pad of EP1398279 is that, after use, the pad is left in a very wet state which is unpleasant for a user to handle when removing the pad manually from the beverage preparation machine. This can lead to dripping and soiling of the machine and surroundings as the pad is transported to a waste receptacle.

A further disadvantage of the known pads and the pads of EP1398279 is that, because substantial quantities of the water soluble substance can typically be left within the pad even at the end of a dispense cycle, the pad-holding section of the beverage preparation machine is left in a soiled state which is contaminated with beverage. As a result, the machine must be cleaned before a next beverage can be hygienically dispensed. The cleaning either involves manually disassembling the beverage preparation machine and washing the parts or by running another dispense cycle with no pad within the pad holding section so as to flush the beverage preparation machine. Both of these methods involves extra time and inconvenience to the user.

A further disadvantage of the pads of EP1398279 is that the water velocity within the pad is low and insufficient to cause mixing and hence improve the rate of dissolution of the soluble substance.

It is an object of the present invention to provide a pad which helps to alleviate at least some of these disadvantages.

Accordingly, the present invention provides a flexible pad for preparing a beverage comprising:

a flexible bag defining a storage volume;

the storage volume containing a water-soluble composition or a combination or mixture of water-soluble compositions for forming a beverage;

wherein at least a part of the flexible bag is formed from a flexible water-impermeable thin sheet material, wherein said a flexible water-impermeable thin sheet material comprises one or more apertures defining an inlet of the storage volume.

Advantageously, use of a flexible water-impermeable thin sheet material produces a pad that is cleaner and easier for a user to handle before and after use. The degree of dripping from the pad is significantly reduced compared to filter bags of the prior art. The flexible water-impermeable thin sheet material also helps to keep the ingredients in the pad fresh by reducing oxidisation. The flexible water-impermeable thin sheet pad is flexible and able to accommodate its shape to fit a variety of shapes of pad holders in beverage preparation machines. The flexible water-impermeable thin sheet material is suitable for use in thin films or laminates which reduces weight and costs of materials and increases the flexibility of the pad.

An upper portion of the flexible bag may be formed from flexible water-impermeable thin sheet material.

A lower portion of the flexible bag may be formed from flexible water-impermeable thin sheet material.

The upper portion may comprise the inlet apertures. Alternatively, the upper portion may comprise the outlet apertures.

The lower portion may comprise the inlet apertures. Alternatively, the lower portion may comprise the outlet apertures.

A lower portion of the flexible bag may be formed from a filtering material and defines an outlet of the storage volume. Alternatively, an upper portion of the flexible bag may be formed from a filtering material and defines an outlet of the storage volume.

The filtering material may be a filter paper.

In one embodiment the flexible bag is substantially wholly formed from flexible water-impermeable thin sheet material.

Optionally the apertures in the flexible water-impermeable thin sheet material are covered by a filtering material. This filtering material may be a filter paper.

The apertures in the flexible water-impermeable thin sheet material may be 1 to 5000 microns in equivalent diameter, preferably 10 to 700 microns in equivalent diameter, more preferably 100 to 700 microns in equivalent diameter, more preferably, 300 to 700 microns in equivalent diameter.

The inlet apertures may be located at or near a centre of the flexible bag. Alternatively, the inlet apertures may be located at or near a periphery of the flexible bag.

The inlet apertures may be located in at least two discrete regions of the flexible bag. In particular, a portion of the apertures of the inlet may be located at or near a centre of the flexible bag and a portion of the apertures of the inlet may be located at or near a periphery of the flexible bag.

The apertures may be arranged uniformly or randomly across the surface or a portion of the surface of the pad.

The apertures of the inlet may be arranged in a circle. The flexible bag may comprise an upper portion and a lower portion which are initially separate and are then sealed around a periphery to form the flexible bag. Alternatively the flexible bag may comprise an upper portion and a lower portion which are formed from a single piece of flexible water-impermeable thin sheet material which is folded and sealed to form the flexible bag.

The flexible water-impermeable thin sheet material may be formed from an elastomer, a polymer, a plastic, a metallic or foilized material or a foamed plastic material.

The flexible water-impermeable thin sheet may be formed as a single sheet of material or a laminate of one or more materials.

The flexible water-impermeable thin sheet may be formed from a flexible laminate formed from one or more of polyethylene, polypropylene, polystyrene, PET, EVOH, polyurethane, polyvinyl, Nylon, foil or similar.

The laminate may comprise a layer of metallised PET which is 7 to 20 microns thick.

The laminate may comprise a layer of PE which is 50 to 100 microns thick.

The laminate may comprise a layer of aluminium which is 7 to 9 microns thick.

The laminate may comprise a layer of aluminium foil which is 30 to 100 microns thick.

The flexible water-impermeable thin sheet material may have an overall thickness of 25 to 500 microns preferably, 50 to 300 microns.

The flexible bag may be circular with a diameter of between 30 and 110 mm. Preferred diameters for the pad are between 60 and 70 mm, between 30 and 40 mm and between 100 and 110 mm. The diameter of the bag will depend on the nature of the beverage preparation machine for use with the pads.

In one embodiment, the storage volume further contains one or more spongiform or foamed plastic elements. The spongiform element or elements may be any suitable material which possesses the porous and water-retaining characteristics of a sponge. An advantage is that the one or more spongiform elements provide a structure which prevents collapse of the flexible bag. The one or more spongiform elements provide an inexpensive and straightforward mechanism for improving the dissolution of the water soluble substance contained in the storage volume of the flexible bag by ensuring that the bag does not collapse during the dispense cycle. The provision of one or more spongiform elements in the storage volume does not greatly complicate the structure of the pad and leads to minimal additional complexity in the manufacturing process. The foamed plastic element may be formed with air or other gases. The foamed plastic may absorb water or may contain closed cells so the material does not substantially absorb water.

The spongiform or foamed plastic element may be circular and sized to fit the filter bag. For example, before exposure to liquid, the diameter may be 10 to 105 mm, preferably, 10 to 65 mm, or 10 to 45 mm depending on the size of the filter bag.

Preferably the ratio by weight of the water soluble substance to the absorbent material before use is from 20:1 to 2:1.

In a preferred embodiment, the filter bag may have a diameter of substantially 69 mm and the spongiform or foamed plastic element may have a diameter of substantially 55 mm.

The spongiform or foamed plastics provide an inexpensive method of directing water flow from the beverage preparation machine through the pad by providing a flexible seal with the pad holder of the machine.

In another embodiment the storage volume may further contain a plurality of non-soluble absorbent particles having a particle size, before use, of between 25 microns and 10 mm. The absorbent particles may be spongiform or a hydrogel material, a starch or a combination or mixture thereof. The absorbent spongiform particles may be formed from compressed cellulose sponge. Examples of suitable compressed sponge include the compressed cellulose sponge products F-11, F-12 and F-13 Wet Pack sponges manufactured by 3M. The compressed sponge exhibits good expansion behaviour in contact with water and has good water absorbency in the expanded state. The sponge is stable and is of food grade quality which is suitable for storing in contact with beverage ingredients. For example, natural sponge. Dried seaweed can form a suitable alternative material.

In one embodiment, before exposure to liquid, the one or more absorbent elements take the form of, or are compressed into the form of, a sheet or sheets. By using a compressed form the dimensions and volume of the one or more absorbent elements before dispensing may be minimised. This helps to reduce the overall size of the pads allowing for smaller packages of pads to be produced. The sheet or sheets of absorbent material may comprise one or more apertures. These apertures, on a large scale compared to the pores of the absorbent material, allow through flow of water in use.

Before exposure to liquid, the sheet or sheets may have a thickness of between 1 and 5 mm. Preferably, on exposure to liquid, the sheet or sheets are expandable so as to have a thickness of between 5 and 35 mm. The expansion in thickness of the material may be between 100 and 1000%. Preferably, the expansion in thickness of the material is between 400 and 500%.

In another embodiment, before exposure to liquid, the one or more spongiform elements take the form of a porous mass or masses. In this embodiment the one or more spongiform elements are at all times in an expanded form.

Suitable hydrogels include poly (HEMA) 2 hyroxyethyl methacrylate, polyacrylic, polyacyrylamide, Gelatine, Alginates, Agar and Carrageenan, and other hydrocolloids.

In one embodiment the one or more absorbent elements interact with water in use such as to absorb water only during a portion of a dispense cycle. For example, the one or more absorbent elements or particles may interact with water at a predetermined temperature, pH or a start of a specified chemical reaction. Preferably, the one or more absorbent elements comprise a soluble coating which, in use, is dissolvable in water to allow absorption of water to take place. For example, the soluble coating may comprise sugar or gelatine.

Preferably, in use, the one or more spongiform or foamed plastic elements or absorbent particles act as a support means for spacing apart an upper and a lower sheet of the filter bag. The physical contact between the one or more spongiform elements or absorbent particles and the flexible bag acts to prevent collapse of the flexible bag. The one or more spongiform elements or absorbent particles help prevent the upper sheet and lower sheet of the foilized material coming into contact with one another during use and as a result help to prevent the formation of low resistance short-circuits for water flow through the pad.

Advantageously, in use, the one or more spongiform elements or absorbent particles act as an absorbent means for retaining excess moisture. The water retaining properties of the spongiform elements and absorbent particles help to retain the majority of any excess water that is left within the pad after the end of the dispense cycle. As a result the user may pick up the used pad and remove it to a waste receptacle with less soiling or dripping. In addition, the water absorbency of the spongiform elements and absorbent particles means that less liquid is left in the pad holding section of the beverage preparation machine. As a consequence, cleaning of the machine is made easier.

The water-soluble composition may be agglomerated. The agglomerated water-soluble composition may be produced by contacting the water-soluble composition with steam, water, or aqueous solution or dispersion to effect agglomeration, and optionally, either simultaneously or subsequently drying the agglomerated composition. In a comparison test, the amount of powder residue left in a standard pad was reduced from 50% to 35% when using an agglomerated powder rather than a non-agglomerated powder.

For the purposes of the present invention, water-soluble substances or compositions are defined as substances which wholly or substantially dissolve in the presence of a solvent which will typically be water. The ingredient composition of the substance before and after dissolution is substantially the same (excluding the diluting effect of the solvent). Thus, water-soluble substances exclude infusible substances such as roast and ground coffee and leaf tea. With infusible substances the ingredient composition of the infusion is substantially different to the ingredient composition of the infusible or extractable precursor since the infusion only contains certain flavour and/or aromatic qualities of the infusible substance. Examples of water-soluble substances according to the present invention include compositions such as milk powder, creamer powder, instant whitener, instant coffee, instant tea, instant soup, instant chocolate drink, sugar, instant fruit juice and instant dessert powders.

Preferably the water-soluble composition is a milk powder, creamer powder or chocolate powder. The milk powder or creamer powder may be a dairy or non-dairy spray-dried coffee creamer or coffee whitener. A fat component of the milk powder or creamer powder may have a melting point of 10 to 40 degrees Celsius.

The creamer powder may comprise one or more of vegetable fat, milk proteins, emulsifiers, stabilisers, foaming agents, milk fat, soy proteins, modified starches, carriers, fillers, sweeteners, flavours, colours, nutrients, preservatives and flow agents.

The inlet apertures may be covered prior to use by peelable or tear-of covers to prevent ingress of moisture into the storage volume.

The storage volume may contain or comprise a spongiform or foamed plastic material and the water-soluble composition may be held prior to dispensation, within pores or surface indentations of the spongiform material. The spongiform or foamed plastic material may have a pore size of 1 to 200 microns.

The inlets may be circular, square or slits or other geometric shape.

The inlets and or outlets may open under the action of water and or heat. The present invention also provides a beverage brewing kit comprising a flexible pad as described above in combination with a flexible pad containing one or more beverage ingredients suitable for brewing.

The second flexible pad may contain roast and ground coffee.

The first and second pads may be joined prior to use.

The present invention further provides a method of dispensing a beverage using a flexible pad as described above comprising the step of passing water downwardly through the flexible pad such that beverage initially exits the flexible pad through a lowermost surface thereof.

Alternatively water may pass upwardly through the flexible pad such that beverage initially exits the flexible pad through an uppermost surface thereof.

Alternatively the flexible pad may be orientated in a non-horizontal orientation, such as a vertical orientation, and water passed in a vertical or non-vertical direction through the flexible pad.

Flow of water through the pad may be substantially parallel to a major axis of the pad or substantially cross-ways to a major axis of the pad or in a direction part-way between parallel flow and cross flow.

Preferably water is passed through the flexible pad at a temperature greater than 70 degrees Celsius.

Optionally water is passed through the flexible pad as a discontinuous flow. Optionally, water is in the form of a pulsed flow. A beverage is prepared using the pads of the present invention by inserting the pads in a beverage preparation machine. The pads may be used in a variety of beverage preparation machines. In one example, the beverage preparation machine generally comprises a housing containing a water heater, a water pump, optionally an air compressor, a control processor, a user interface and a head. The head in turn generally comprises a holder for holding, in use, the pad. The beverage preparation machine is also provided with a water tank.

The housing comprises a dispense station where dispensation of the beverage takes place. The dispense station comprises a receptacle stand having a hollow interior forming a drip tray.

The head is located towards the top of the housing above the receptacle stand. The holder of the head is shaped to receive the pad of the present invention and to hold the pad in the correct orientation such that water may be passed through the pad. Preferably the holder and head are provided with sealing means for sealing around a periphery of the pad to prevent by-pass flow of water in use. The head may be designed to direct flow of water downwardly through the pad so that beverage exits the pad through a lowermost surface of the pad. Alternatively, the head may be designed to direct flow of water upwardly through the pad so that beverage initially exits the pad through an uppermost surface of the pad before being ultimately directed downwardly to a receptacle. Of course the pad may be used in an orientation other than horizontal, for example, in a vertical orientation.

The user interface is located on the front of the housing and comprises a start/stop button, and a plurality of status indicators.

The start/stop button controls commencement of the operating cycle and is a manually operated push-button, switch or similar.

The water tank is located to the rear of the housing and is connected in use to a water tank station located at a rear half of the housing.

The water pump is operatively connected between the water tank and the water heater and is controlled by the control processor.

The water heater is located in the interior of the housing. The heater is able to heat water received from the water pump from a starting temperature of approximately 20° C. to an operating temperature of around 85° C. in under 1 minute.

The control processor of the beverage preparation machine comprises a processing module and a memory. The control processor is operatively connected to, and controls operation of, the water heater, water pump, air compressor and user interface.

Embodiments of the present invention will now be described, by way of example, with reference to the accompanying drawings in which:

FIG. 1 is an upper plan view of a prior art flexible pad;

FIG. 2 is a cross-sectional view of the flexible pad of FIG. 1;

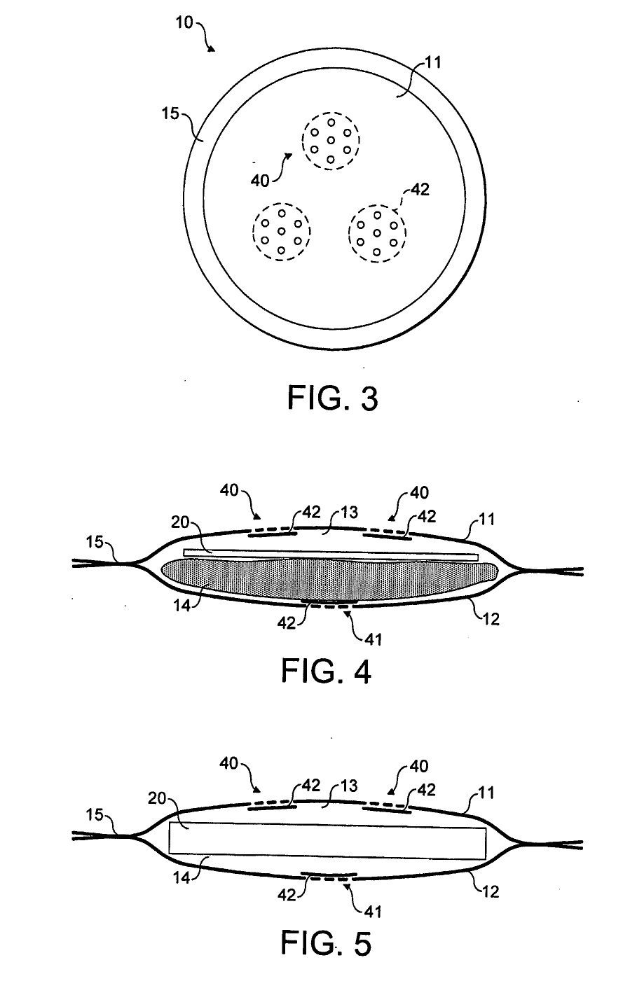

FIG. 3 is a top plan view of a first embodiment of flexible pad according to the present invention prior to use;

FIG. 4 is a cross-sectional view of the flexible pad of FIG. 3, again prior to use; and

FIG. 5 is a cross-sectional view of the flexible pad of FIG. 3 after use.

FIGS. 3 to 5 illustrate a first embodiment of flexible pad according to the present invention. The pad 10 comprises an upper sheet 11 and lower sheet 12 of thin sheet water-impermeable material which are joined by heat, adhesive or similar means around a periphery seam 15 to produce a flexible bag which defines a storage volume 13. The material my be a single sheet or a laminate of one or more materials. In the following description the material will be described by way of example as a foilized material.

The foilized material may be a flexible laminate comprising two or more layers. The flexible laminate may be formed for example from any or a combination of polyethylene, polypropylene, polystyrene, PET, EVOH, Nylon polyurethane, aluminium foil or similar. In one example the laminate (known as duplex) comprises a 60 to 100 micron layer of PE and a 7 to 12 micron layer of metallised PET. Another example comprises a laminate (known as triplex) of a 50 to 100 micron layer of PE, a 7 to 9 micron layer of Aluminium and a 12 to 20 micron layer of PET. Both laminates are available from Alcon under the trade name AMOR. A quadruplex laminate may be formed by the addition a metallised PET layer to the triplex laminate.

In another example the laminate may be 100 micron of cast polypropylene, 80 micron of cast polyamide, adhesive coated on both sides and 80 micron polythene. This material may be thermo formed to match the shape of the pad holder of the beverage preparation machine to be used.

The upper sheet 11 of foilized material comprises a plurality of apertures 40 forming an inlet to the storage volume 13. The lower sheet 12 is also formed from foilized material and comprises a plurality of apertures 41 forming an outlet of the pad 10.

The apertures 40, 41 may simply comprise holes or slits in the foilized material which are dimensioned to prevent egress of the water-soluble substance but allow transmission of water in use. For example, the apertures preferably have a size of 1 to 1000 microns, preferably 10 to 50 microns where the composition is a milk or creamer powder. Between 1 and 10 or more apertures may be provided. A larger number of apertures may be provided to increase the flow rate through the pad.

In one example the apertures in the thin sheet may be sized to deliver optimum water jetting and water distribution through the pad. The inlet and or outlet apertures may be positioned and numbered so as to control flow dynamics in the pad. The number of apertures at the inlet or outlet may be 1 to 100, more preferably 1 to 63 apertures.

The apertures may have an equivalent diameter of 0.1 mm to 5.0 mm. Preferably the apertures have an equivalent diameter of 0.3 to 0.7 mm when there are 14 to 19 apertures.

The apertures 40, 41 may be arranged in an ordered or random configuration in the upper sheet 11 and lower sheet 12.

Alternatively, and as illustrated the apertures may be larger and covered by filter material 42. The filter material may only cover the apertures 40, 41 or may extend over a greater proportion of the upper sheet 11 and lower sheet 12. The filter material 42 may be bonded to the foilized material either on the inner or outer surfaces of the upper sheet and lower sheet.

Before use, the apertures 40, 41 may be closed off by means of a one or more pieces of material which can be peeled or teared of the upper and lower surfaces 11, 12 prior to use. Alternatively, the apertures are closed off prior to use but open in use due to water flow and or increased temperature. An example is the use of a flexible material containing EVOH with pre-made holes that remain closed when dry but open up with a flow of hot water into the pad. Advantageously, but not exclusively these apertures would be used on the outlet of the pad.

The pad may be circular with a diameter of between 30 and 110 mm. Preferred diameters for the pad are between 60 and 70 mm, between 30 and 40 mm and between 100 and 110 mm. The diameter of the pad will depend on the nature of the beverage preparation machine for use with the pads. A particular example of pad 10 has a diameter of 69 mm and the storage volume has a diameter of 59 mm.

The storage volume 13 contains a water soluble substance 14 which when dissolved in water will form a beverage or beverage portion. The invention finds particular application where the water soluble substance 14 is a milk powder or creamer powder. Milk powders include dried skimmed milk, part-skimmed milk, and whole milk, dried milk protein concentrates, isolates, and fractions, or any combination thereof. Creamer powders can be manufactured from dairy and/or non-dairy food ingredients and typically contain emulsified fat, stabilized by protein or modified starch, dispersed in a carrier that facilitates drying, especially spray drying. Optional ingredients include buffers, flavours, colours, fillers, sweeteners, foaming agents, flow agents, nutrients, preservatives, and the like. Milk powders and creamer powders are particularly useful as coffee whiteners for brewed, soluble, and flavoured coffee products, including latte and cappuccino. In the following description, for example only, the water soluble substance will be described as a creamer powder unless the context otherwise requires.

The creamer powder may for example comprise the following by weight:

| | |
|---|---|
| Hardened vegetable fat | 49% |
| Glucose syrup | 41% |
| Sodium Caseinate | 4.5% |
| Polyphosphates - K2HPO4 | 2.0% |
| Na-Polyphosphate | 2.5% |
| Silicon dioxide | 0.25% |
| Emulsifier (Sodium stearoyl-2-lactylate) | 0.75% |

Other compositions may be used which contain fillers such as lactose and additional stabilisers. Additional emulsifiers may be added to improve wetting. Advantageously, the creamer may be provided in an agglomerated form to assist and improve solubility. Advantageously, the creamer powder may comprise a low melting temperature fat having a melting temperature of between 10 and 40 degrees Celsius. Some or all of the fat content of the composition noted above may be substituted for low melting temperature fat. In one example the composition comprises 24% low melting temperature fat and 25% fat with a melting temperature of above 40 degrees Celsius. This results in a reduction of creamer powder residue in the pad of around 15 to 20%.

In the present example the storage volume 13 also advantageously contains a spongiform element in the form of a circular disc 20 of compressed sponge material. The disc has preferred diameters of 100 to 100 mm, 50 to 59 mm and 30 to 40 mm and a thickness of 3 mm. The disc 20 is formed from cellulose sponge such as that manufactured by 3M. Other suitable materials for the spongiform element include other food grade materials with similar physical properties to those of cellulose sponge in terms of there porosity and or expandability. For example, natural sponge. Dried seaweed can form a suitable alternative material.

Prior to use of the flexible pad 10, the pad 10 and its contents are dry. If necessary, the pad 10 can be supplied in an hermetically sealed package to prevent moisture ingress or absorption.

As shown in FIG. 4, the compressed sponge disc 20 may be positioned on top of the creamer powder 14 within the storage chamber 13. Alternatively, the compressed sponge 20 may be positioned underneath the creamer powder 14 or within the mass of the creamer powder 14.

In use, the flexible pad 10 is placed in a suitable beverage preparation machine and water is passed through the pad 10. Preferably the water is hot water where the water soluble substance is a creamer powder. The water is free to pass through the apertures 40 in the upper sheet 11 of the foilized material and the apertures 41 in the lower sheet 12 of the foilized material. On contact with the water, the compressed sponge 20 rapidly expands. In the expanded state the disc 20 has a thickness of between 10 and 20 mm, preferably 15 mm. Thus, the action of the liquid on the compressed sponge 20 is to produce an expansion in the thickness of the compressed sponge 20 of around 500%. The compressed sponge 20 may be configured to expand generally only in one dimension, i.e. its thickness, or may be configured to expand three-dimensionally, i.e. to increase it's thickness and also it's diameter. Water is able to pass through the expanded compressed sponge 20 substantially unhindered. As a result, the water quickly contacts and dissolves the creamer powder 14 to produce the milk based beverage or beverage portion. The beverage containing the dissolved creamer powder 14 passes through the apertures 41 in the lower foilized sheet 12 and out of the beverage preparation machine.

In its expanded state shown in FIG. 5, the spongiform element 20 acts to maintain a separation of the upper sheet 11 of foilized material and the lower sheet 12 of foilized material by physically contacting both sheets. This advantageously helps to maintain the storage volume 13 as a single volume through which the water can easily circulate. In particular, the upper and lower sheets 11, 12 are prevented from collapsing into contact with one another and thereby producing a low resistance flow path for water. In addition, the presence of the spongiform element 20 is believed to improve the lateral spread of the water within the storage volume 13.

After use, the user of the beverage preparation machine removes the flexible pad 10 and disposes of it in a waste receptacle. Advantageously, the porous water-retaining nature of the spongiform element 20 helps to retain excess moisture that may be within the pad 10. The capillary action of the pores of the spongiform element 20 help to prevent dripping from the pad as it is transferred to a waste receptacle. In addition, the water-retaining nature of the spongiform element has the consequence that the pad holding section of the beverage preparation machine contains less moisture and hence less contamination than compared with the use of prior art pads. As a result the machine is easier to clean and prepare in readiness for the next dispense cycle.

It has been found that the presence of the spongiform element within the storage volume improves the dissolution of the creamer powder. Experiments were carried out using the pad of FIGS. 1 and 2 as a control. The experiments were carried out using a single serve brew machine that is suitable for use with such pads. It was found that with a standard creamer powder, 60% of the composition remained as residue within the pad of FIGS. 1 and 2 after the dispense cycle. With the pad 10 of FIGS. 3 to 5 the amount of creamer residue remaining within the storage volume 13 was reduced to 10 to 20%.

In a non-illustrated embodiment, the spongiform element is provided in the form of an annular ring 21 of compressed sponge. The ring has an outer diameter of 55 mm and an inner diameter of 30 mm. The thickness of the sponge before and after exposure to water was as described in the first embodiment. The dimensions of the ring 21 are such that the material of the compressed sponge is located towards the periphery of the storage volume 13 of the flexible pad 10.

Shaping the spongiform element as an annular ring rather than a disc allows for a greater flow rate of water through the central part of the pad.

In another non-illustrated embodiment the spongiform element is provided with a covering of filter material. The filter material preferably fully encloses the spongiform element and may be bonded to one or more surfaces of the spongiform element. Where the spongiform element is always in the expanded state (in other words not compressed prior to exposure to water) the filter material may be bonded to all external surfaces of the spongiform element. However, where the spongiform element is designed to expand in use, the filter material would not be bonded to all external surfaces but may be bonded to one or more surfaces, preferably the upper and lower surfaces, so as to allow the sponge to expand on exposure to water. The filter material helps to prevent passage of the creamer powder into the interior of the spongiform element before it has been dissolved during dispensation. This results in improved dispensation of the water soluble substance from the flexible pad.

In another non-illustrated embodiment the spongiform element is provided with an impermeable barrier on a lowermost surface of the spongiform element. The barrier may take the form of an impermeable material which is bonded to the spongiform element or alternatively may be part of the spongiform element whose material characteristics are modified during manufacture so as to make it impermeable to water. For example, a sponge or foam structure with a generally open-celled construction may have one surface formed with a closed cell structure or skin by use of heat during manufacture.

In another non-illustrated embodiment, the storage volume 13 contains a plurality of absorbent particles in the form of particles of compressed sponge material. The particles 20 each a size (diameter or length) of 1 to 10 mm and a thickness of 1 to 3 mm before use. The particles 20 are formed from compressed cellulose sponge. Preferably the ratio by weight of the creamer powder to the absorbent particles before use is from 20:1 to 2:1, preferably around 3:1. As an alternative to sponge particles, a hydrogel substance may be used in the form of spherical or otherwise shaped particles. Suitable hydrogels include poly (HEMA) 2 hyroxyethyl methacrylate, polyacrylic, polyacyrylamide, Gelatine, Alginates, Agar and Carrageenan, and other hydrocolloids.

In use, and on contact with water, the sponge or hydrogel particles absorb water and expands. The expansion aids dissolution of the creamer powder and also acts as a physical support for the flexible bag.

The water soluble substance has been described as preferably being a milk- or dairy-based creamer powder. However the pads of the present invention may also find application with other soluble ingredients such as instant coffee, instant tea, chocolate, soup or dessert ingredients.

In the above description, the storage chamber 13 has been described as a unitary volume. However, the volume may be separated into multiple compartments using flexible materials. The chambers may if desired contain different beverage ingredients or the same ingredients. Some or all of the compartments may comprise absorbent bodies of the types described above. Some or all of the compartments may have dispersion discs contained therein.

In the above embodiments, the pad 10 has been described as advantageously containing spongiform or absorbent elements. However, the invention in its broadest scope includes pads without such inserts as made clear in the attached claims.

The pad may be used for dispensing hot and cold beverages. Still and carbonated beverages may be produced by using still or carbonated water.

The pad may also contain a dispersion plate for creating a non-vertical flow of water, in use, within the storage volume.

The dispersion plate may be freely suspended within the storage volume. Alternatively the dispersion plate is attached to the foilized or filtering material. Alternatively the dispersion plate is formed in the plane of the foilized or filtering material. The dispersion plate may form part of an outlet filtering means.

The dispersion disc or plate may comprise a portion of the outlet filtering means which has modified material characteristics and is non-transmissive to water.

The outlet filtering means may comprise a filter paper and the dispersion disc comprises a portion of the filter paper which is hot stamped to render it impermeable to water.

The dispersion plate may be planar. Alternatively, the dispersion plate may be rippled, ridged or otherwise convoluted.

The dispersion plate may be non-apertured or may comprise one or more apertures. The dispersion disc may be sealed or bonded to the filter or foilized material and the one or more apertures may be formed at the boundary between the dispersion plate and the filter or foilized material. The dispersion plate may extend wholly or partially across the pad. The dispersion plate may be positioned to increase the path length through the pad and increase the water velocity within the pad.

The flexible pad of the present invention may be provided with one or more structural supports in addition to the absorbent particles which span between opposed faces of the pad.

1. A flexible pad for preparing a beverage comprising: a flexible bag defining a storage volume; the storage volume containing a water-soluble composition or a combination or mixture of water-soluble compositions for forming a beverage; wherein at least a part of the flexible bag is formed from a flexible water-impermeable thin sheet material, wherein said flexible water-impermeable thin sheet material comprises one or more apertures defining an inlet or an outlet of the storage volume.

2. A flexible pad as claimed in claim 1 wherein an upper portion of the flexible bag is formed from flexible water-impermeable thin sheet material.

3. A flexible pad as claimed in claim 1 wherein a lower portion of the flexible bag is formed from flexible water-impermeable thin sheet material.

4. A flexible pad as claimed in claim 2 wherein the upper portion comprises the inlet apertures.

5. A flexible pad as claimed in claim 2 wherein the upper portion comprises the outlet apertures.

6. A flexible pad as claimed in claim 3 wherein the lower portion comprises the inlet apertures.

7. A flexible pad as claimed in claim 3 wherein the lower portion comprises the outlet apertures.

8. A flexible pad as claimed in claim 1 wherein a lower portion of the flexible bag is formed from a filtering material and defines an outlet of the storage volume.

9. A flexible pad as claimed in claim 1 wherein an upper portion of the flexible bag is formed from a filtering material and defines an outlet of the storage volume.

10. A flexible pad as claimed in claim 8 wherein the filtering material is a filter paper.

11. A flexible pad as claimed in claim 1 wherein the flexible bag is substantially wholly formed from flexible water-impermeable thin sheet material.

12. A flexible pad as claimed in claim 11 wherein the apertures in the flexible water-impermeable thin sheet material are covered by a filtering material.

13. A flexible pad as claimed in claim 12 wherein the filtering material is a filter paper.

14. A flexible pad as claimed in claim 1 wherein the apertures in the flexible water-impermeable thin sheet material are 1 to 5000 microns in equivalent diameter.

15. A flexible pad as claimed in claim 14 wherein the apertures are 10 to 700 microns in equivalent diameter.

16. A flexible pad as claimed in claim 14 wherein the apertures are 100 to 700 microns in equivalent diameter.

17. A flexible pad as claimed in claim 14 wherein the apertures are 300 to 700 microns in equivalent diameter.

18. A flexible pad claim 1 wherein the inlet apertures are located at or near a centre of the flexible bag.

19. A flexible pad as claimed in claim 1 wherein the inlet apertures are located at or near a periphery of the flexible bag.

20. A flexible pad as claimed in claim 1 wherein the inlet apertures are located in at least two discrete regions of the flexible bag.

21. A flexible pad as claimed in claim 20 wherein a portion of the apertures of the inlet are located at or near a centre of the flexible bag and a portion of the apertures of the inlet are located at or near a periphery of the flexible bag.

22. A flexible bag claim 21 wherein the apertures of the inlet are arranged in a circle.

23. A flexible pad claim 1 wherein the flexible bag comprises an upper portion and a lower portion which are initially separate and are then sealed around a periphery to form the flexible bag.

24. A flexible pad as claimed in claim 11 wherein the flexible bag comprises an upper portion and a lower portion which are formed from a single piece of flexible water-impermeable thin sheet material which is folded and sealed to form the flexible bag.

25. A flexible pad as claimed in claim 24 wherein the flexible water-impermeable thin sheet material is formed from an elastomer, a polymer, a plastic, a metallic or foilized material or a foamed plastic material.

26. A flexible pad as claimed in claim 25 wherein the flexible water-impermeable thin sheet is formed as a single sheet of material or a laminate of one or more materials.

27. A flexible pad as claimed in claim 26 wherein the flexible water-impermeable thin sheet is formed from a flexible laminate formed from one or more of polyethylene, polypropylene, polystyrene, PET, EVOH, polyurethane, polyvinyl, Nylon, foil or similar.

28. A flexible pad as claimed in claim 19 wherein the laminate comprises a layer of metallised PET.

29. A flexible pad as claimed in claim 28 wherein the layer of PET is 7 to 20 microns thick.

30. A flexible pad as claimed in claim 27 wherein the laminate comprises a layer of PE.

31. A flexible pad as claimed in claim 30 wherein the layer of PE is 50 to 100 microns thick.

32. A flexible pad as claimed in claim 27 wherein the laminate comprises a layer of aluminium.

33. A flexible pad as claimed in claim 32 wherein the layer of aluminium is 7 to 9 microns thick.

34. A flexible pad as claimed in claim 32 wherein the laminate comprises a layer of aluminium foil.

35. A flexible pad as claimed in claim 34 wherein the layer of aluminium foil is 30 to 100 microns thick.

36. A flexible pad claim 27 wherein the flexible water-impermeable thin sheet material has an overall thickness of 25 to 500 microns.

37. A flexible pad as claimed in claim 36 wherein the flexible water-impermeable thin sheet material has an overall thickness of 50 to 300 microns.

38. A flexible pad as claimed in claim 1 wherein the flexible bag is circular with a diameter of 30 to 110 mm.

39. A flexible pad as claimed in claim 38 wherein the storage volume further contains one or more spongiform or foamed plastic elements.

40. A flexible pad as claimed in claim 39 wherein the spongiform or foamed plastic element is circular with a diameter, before exposure to liquid, of 10 to 105 mm.

41. A flexible pad as claimed in claim 1 wherein the storage volume further contains a plurality of non-soluble absorbent particles having a particle size, before use, of between 25 microns and 10 mm.

42. A flexible pad as claimed in claim 41 wherein the absorbent particles are spongiform.

43. A flexible pad as claimed in claim 42 wherein the absorbent spongiform particles are formed from compressed cellulose sponge.

44. A flexible pad as claimed in claim 41 wherein the absorbent particles are formed from an hydrogel, starch, spongiform or a combination of said materials.

45. A flexible pad as claimed in claim 41 wherein, in use, the one or more spongiform or foamed plastic elements or absorbent particles act as a support means for spacing apart an upper and a lower sheet of the filter bag.

46. A flexible pad as claimed in claim 45 wherein, in use, the one or more spongiform elements or absorbent particles act as an absorbent means for retaining excess moisture.

47. A flexible pad as claimed in claim 1 wherein the water-soluble composition is agglomerated.

48. A flexible pad as claimed in claim 47 wherein the agglomerated water-soluble composition is produced by contacting the water-soluble composition with steam, water, or aqueous solution or dispersion to effect agglomeration, and optionally, either simultaneously or subsequently drying the agglomerated composition.

49. A flexible pad as claimed in claim 48 wherein the water-soluble composition is a milk powder, creamer powder or chocolate powder.

50. A flexible pad as claimed in claim 49 wherein the milk powder or creamer powder is a dairy or non-dairy spray-dried coffee creamer or coffee whitener.

51. A flexible pad as claimed in claim 50 wherein a fat component of the milk powder or creamer powder has a melting point of 10 to 40 degrees Celsius.

52. A flexible pad as claimed in claim 49 wherein the creamer powder comprises one or more of vegetable fat, milk proteins, emulsifiers, stabilisers, foaming agents, milk fat, soy proteins, modified starches, carriers, fillers, sweeteners, flavours, colours, nutrients, preservatives and flow agents.

53. A flexible pad as claimed in claim 1 wherein the inlet apertures are covered prior to use by peelable or tear-of covers to prevent ingress of moisture into the storage volume.

54. A flexible pad as claimed in claim 53 wherein the storage volume contains or comprises a spongiform or foamed plastic material and the water-soluble composition is held prior to dispensation, within pores of the spongiform or foamed plastic material.

55. A flexible pad as claimed in claim 43 wherein the spongiform or foamed plastic material has a pore size of 1 to 200 microns.

56. A flexible pad as claimed in claim 1 wherein the inlets are circular, square or slits or other geometric shapes.

57. A flexible pad as claimed in claim 56 wherein the inlets and or outlets open under the action of water and or heat.

58. A beverage brewing kit comprising a first flexible pad as claimed in claim 57 in combination with a second flexible pad containing one or more beverage ingredients suitable for brewing.

59. A beverage brewing kit as claimed in claim 58 wherein the second flexible pad contains roast and ground coffee.

60. A beverage brewing kit as claimed in claim 58 wherein the first and second pads are joined prior to use.

61. A method of dispensing a beverage using a flexible pad as claimed in claim 57 comprising the step of passing water downwardly through the flexible pad such that beverage initially exits the flexible pad through a lowermost surface thereof.

62. A method of dispensing a beverage using a flexible pad as claimed in claim 57 comprising the step of passing water upwardly through the flexible pad such that beverage initially exits the flexible pad through an uppermost surface thereof.

63. A method of dispensing a beverage using a flexible pad as claimed in claim 1 comprising the step of orientating the flexible pad in a non-horizontal orientation and passing water in a vertical or non-vertical direction through the flexible pad.

64. A method of dispensing a beverage using a flexible pad as claimed in claim 1 wherein flow of water through the pad may be substantially parallel to a major axis of the pad or substantially cross-ways to a major axis of the pad or in a direction part-way between parallel flow and cross flow.

65. A method of dispensing a beverage using a flexible pad as claimed in claim 1 comprising the step of passing water through the flexible pad at a temperature greater than 70 degrees Celsius.

66. A method of dispensing a beverage using a flexible pad as claimed in claim 1 comprising the step of passing water through the flexible pad as a discontinuous flow.

67. A method of dispensing a beverage as claimed in claim 66 wherein the discontinuous flow of water is a pulsed flow.
